(19) United States
(12) Patent Application Publication
(10) Pub. No.: US 2012/0012704 A1
(43) Pub. Date: Jan. 19, 2012

(54) ACCOMMODATION MODULE WITH SEPARATE PRIVATE AREA

(75) Inventors: Michael Mosler, Plaisance Du Touch (FR); Jovan Ulbrich-Gasparevic, Pinneberg (DE)

(73) Assignee: AIRBUS OPERATIONS GMBH, Hamburg (DE)

(21) Appl. No.: 13/181,665

(22) Filed: Jul. 13, 2011

Related U.S. Application Data
(60) Provisional application No. 61/364,124, filed on Jul. 14, 2010.

(30) Foreign Application Priority Data
Jul. 14, 2010 (DE) 10 2010 027 122.5

(51) Int. Cl. B64D 11/00; E06B 9/08; B60R 99/00

(52) U.S. Cl. 244/118.5; 160/238; 160/120; 160/266; 160/127; 160/166.1

(57) ABSTRACT

Indicated herein is a lounge module for crewmembers of an aircraft, which exhibits a screen device, such as a privacy roller blind. This privacy roller blind can be used to visually demarcate a first aisle area from a second aisle area, thereby creating a private area for the aircraft crew.

### CROSS-REFERENCE TO RELATED APPLICATIONS

This application claims the benefit of the filing date of U.S. Provisional Patent Application No. 61/364,124 filed Jul. 14, 2010, the disclosure of which is hereby incorporated herein by reference.

### BACKGROUND OF THE INVENTION

The invention relates to cabin areas of transport means. In particular, the invention relates to an accommodation module (also called lounge module) for crewmembers of a transport means (an aircraft, ship, train, bus, or other conveyance), an arrangement with an accommodation module and two monuments, as well as an aircraft with an accommodation module or such an arrangement.

In contemporary aircraft, accommodation or lounge modules are used for passengers or aircraft crewmembers, for example located in a crown area of the aircraft cabin, for example. In this case, reference is also made to so-called overhead crew rest compartments. These lounge modules can also incorporate so-called “changing areas”, meaning crewmember changing areas. The space available for this purpose in lounge modules is limited.

Privacy roller blinds can be used to furnish partitions inside the cabin. For example, privacy roller blinds are known from DE 10 2009 005 905 A1. DE 10 2007 035 681 A1 and US 2009/0289146 A1 describe lounge modules for accommodating aircraft crewmembers. Dockable partial modules are provided, and can be used to expand the space available for the crew.

### SUMMARY OF THE INVENTION

It may be desirable to have an accommodation module with a flexibly usable private area.

Indicated herein is an accommodation module for crewmembers of a transport means, for example an aircraft crew, to be secured in a crown area of a transport means cabin, an arrangement with such an accommodation module, a first monument and second monument, as well as an aircraft with an accommodation module or an arrangement according to the features in the independent claims described above and below. Further aspects of the invention may be gleaned from the subclaims.

The exemplary embodiments described here and below apply equally to the an accommodation module, arrangement and aircraft. In other words, the features described below, for example in relation to the an accommodation module, can also be implemented in the arrangement and aircraft, and vice versa.

The term “lounge module” relates to accommodation modules, such as crew rest compartments, and in particular to overhead crew rest compartments.

A first aspect of the invention indicates an accommodation module for crewmembers of a transport means to be secured in a crown area of a transport means cabin having a first screen device, such as but not limited to a privacy roller blind. The first privacy roller blind can optionally assume a retracted state and extended state. In the extended state, in which the privacy roller blind is pulled down, it establishes a first visual separation of a first aisle area from a second aisle area (for example, the passenger cabin) when at least a part of the accommodation module is installed in the crown area of the aircraft cabin. The first aisle area is here located underneath the part of the accommodation module when at least the part of the accommodation module is installed in the crown area of the transport means cabin, and the second aisle area is adjacent to the first aisle area. In other words, the first privacy roller blind installed on or in the accommodation module can be pulled out, and hence serve as a visual separation from a passenger cabin area.

For example, the transport means can be an aircraft, such as a helicopter, airplane or airship, but also a rail vehicle, road vehicle or water craft.

In an exemplary embodiment of the invention, the accommodation module further exhibits a second privacy roller blind, which is designed to optionally assume a retracted state or extended state. The second privacy roller blind establishes a second visual separation of the first aisle area from a third aisle area in the extended state when the accommodation module is installed in the crown area of the transport means cabin. As with the second aisle area, the third aisle area involves an aisle area that adjoins, i.e., borders the first aisle area.

For example, the first aisle area is situated between the second and third aisle areas.

In another exemplary embodiment of the invention, the first aisle area consists of at least one partial area of a cross aisle between two longitudinal aisles of an aircraft cabin (so-called “cross aisle”).

In another exemplary embodiment of the invention, the accommodation module further exhibits two grooves, which are designed to laterally guide the first privacy roller blind or second privacy roller blind. Naturally, another two grooves can be provided, which are designed to laterally guide the respective other privacy roller blind.

For example, these grooves are milled into the accommodation module or otherwise introduced into the body of the accommodation module, so that no separate rails are required.

The lateral grooves provide a guide for the roller blind for the entire area in which the roller blind is stowed in the crew rest compartment.

This guide rail (if monuments are present) can be allowed to run down to the floor. This may eliminate the need for fold-out panels. The latter may constitute a simple lateral visual obstruction.

In another exemplary embodiment of the invention, the accommodation module exhibits an outer surface, wherein the first privacy roller blind and/or second privacy roller blind is pushed over at least a partial area of the outer surface in the retracted state.

In the retracted state, the privacy roller blind is hence not located inside the accommodation module, but rather on its upper side.

In another exemplary embodiment of the invention, the accommodation module further comprises a right gap cover and left gap cover, which are integrated into the privacy roller blind when moving the privacy roller blind from the retracted state to the extended state. After the privacy roller blind has reached an extended state, the right gap cover and left gap cover can be removed from the latter (e.g., pulled out), so as to visually obstruct a right gap and left gap. These two gaps are each between the privacy roller blind and a monument or other interior furnishing situated adjacent thereto (e.g., a separating wall).

In another exemplary embodiment of the invention, the privacy roller blind is a flexible roller blind.

In another exemplary embodiment of the invention, the privacy roller blind is designed as a roller shutter or Venetian blind, i.e., segmented.

The gap covers may also be segmented. It is also possible for the gap covers (panels) to comprise or consist of a flexible or elastic material, such as silicone.

As an alternative to the paneled gap covers, rails may be secured to the monuments or interior furnishings situated next to the privacy roller blind, serving as guides for the privacy roller blind.

Another aspect of the invention specifies an arrangement with a accommodation module described above and below, as well as a first monument and another interior furnishing, for example a second monument.

This arrangement may be able to create a versatile private area separated from the accommodation module in which a crewmember can change by pulling down the privacy roller blind(s) as needed.

In another exemplary embodiment of the invention, the two monuments and two privacy roller blinds in an extended state, potentially in combination with other elements, such as one or more separating walls or other interior furnishing elements, are designed to isolate and define a separated area (private area). This private area may be used by a crewmember to change clothes. The configuration of the private area can also be large enough to allow several crewmembers to change clothes at the same time.

This private area may be completely visually demarcated, but does not have to be.

In another exemplary embodiment of the invention, the first monument is a step-up module, e.g. a stair house for the accommodation module, and the second monument is a galley.

Another aspect of the invention specifies an aircraft with an accommodation module described above and below or an arrangement described above and below.

The lounge module can also be built into another transport means. For example, this transport means can be a railway wagon, airship, water craft or road vehicle.

Exemplary embodiments of the invention will be described below drawing reference to the figures.

### BRIEF DESCRIPTION OF THE DRAWINGS

FIG. 1A shows a side view of an accommodation module according to an exemplary embodiment of the invention.

FIG. 1B shows a detailed view of an area of the accommodation module on FIG. 1A.

FIG. 1C shows a roller shutter element 150 of a roller blind in an accommodation module according to an exemplary embodiment of the invention.

FIG. 2 shows an arrangement according to an exemplary embodiment of the invention.

FIG. 3 shows the arrangement on FIG. 2 with partially extended privacy roller blind.

FIG. 4 shows the arrangement on FIG. 2 with completely extended privacy roller blind.

FIG. 5A shows an arrangement according to another exemplary embodiment of the invention.

FIG. 5B shows a detailed view of the arrangement on FIG. 5A.

FIG. 5C shows another detailed view of the arrangement on FIG. 5A.

FIG. 6A shows an outline of an arrangement according to an exemplary embodiment of the invention.

FIG. 6B shows an outline of an arrangement according to another exemplary embodiment of the invention.

FIG. 6C shows an outline of an arrangement according to another exemplary embodiment of the invention.

FIG. 7 shows an aircraft according to an exemplary embodiment of the invention.

### DETAILED DESCRIPTION

The depictions on the figures are schematic and not to scale.

The following description of figures uses the same reference numbers for identical or similar elements.

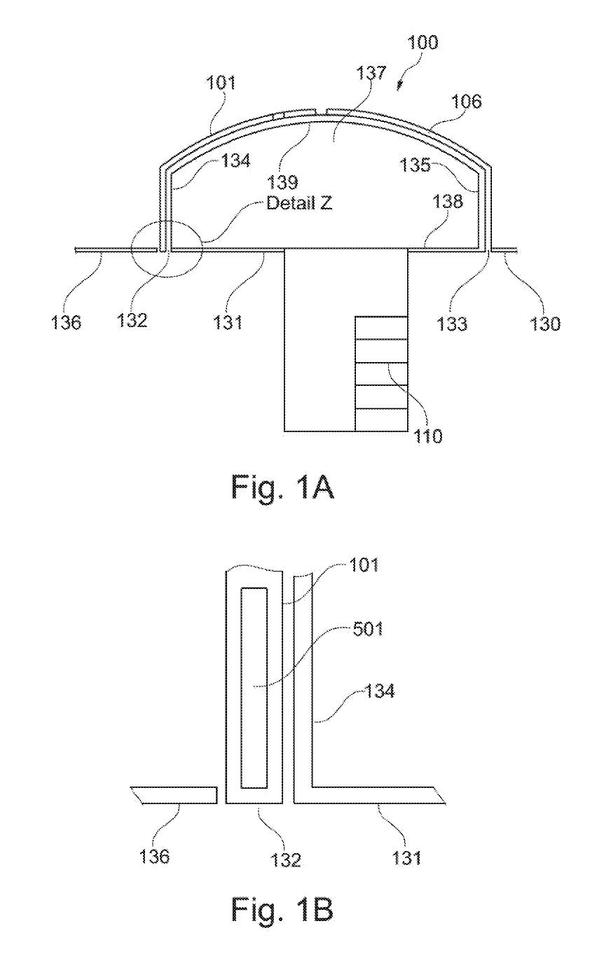

FIG. 1 shows a side view of an accommodation module according to an exemplary embodiment of the invention.

The invention is based on the idea of equipping a crew rest compartment (lounge module) used in the crown area of the aircraft (so-called overhead crew rest compartment) with a device that can be used to create a private changing area for crewmembers. For example, this device exhibits one or more privacy roller blinds secured to the lounge module, if necessary in combination with one or more monuments and/or interior furnishings. The monuments can be a galley and stairway entry to the crew rest compartment (stair house), also referred to as step-up module.

The lounge module 100 exhibits flexible devices 101, 106 to the left and right of the lounge area, for example in the form of privacy roller blinds. The function of these flexible devices 101, 106 can be similar to the function of a conventional roller blind. For example, the privacy roller blinds are segmented. The privacy roller blinds 101, 106 run between corresponding grooves that are milled into the lounge module or otherwise secured thereto. The privacy roller blinds 101, 106 can be delivered together with the lounge module, thereby eliminating the need for subsequent installation. In this case, the roller blinds can be integrated into the module as an optional selection.

For example, the two roller blinds 101, 106 run over the entire surface of the upper area 137 of the lounge module. In this case, the dimensions of the roller blinds can measure about 500 mm by 2000 mm. The dimensions can also be larger or smaller.

The left and right ceiling elements 136, 131 or 138, 130 comprising the cabin ceiling and part of the floor of the upper area 137 of the lounge module 100 incorporate openings 132, 133 through which the corresponding roller blind 101, 106 can be lowered.

In addition, the upper area 137 of the lounge module exhibits left and right wall elements 134, 135, along with an upper ceiling element 139. The elements 134, 135 and 139 exhibit an outer surface along which the roller blinds 101, 106 run.

A step-up module 110 also referred to as a staircase or stair house is additionally provided for entering the lounge module.

FIG. 1B shows the detail z on FIG. 1A. As readily evident, the left privacy roller blind 101 is lowered from above through the opening 132 and passes between the ceiling elements 136, 131. The ceiling element 131 here forms part of the lounge module, and the ceiling element 136 forms part of the cabin ceiling.

The roller blind 101 has an extensible panel 501 that can be arranged inside the roller blind, either on its front side or rear side.

FIG. 1C shows a roller shutter element 150 of the roller blind 101 or 106. A bearing 151 with a slider or roller element 152 adjacent thereto is arranged on both sides of the element 150. The slider or roller element 152 slides or rolls in lateral guide rails or grooves secured to the lounge module 100 or incorporated therein.

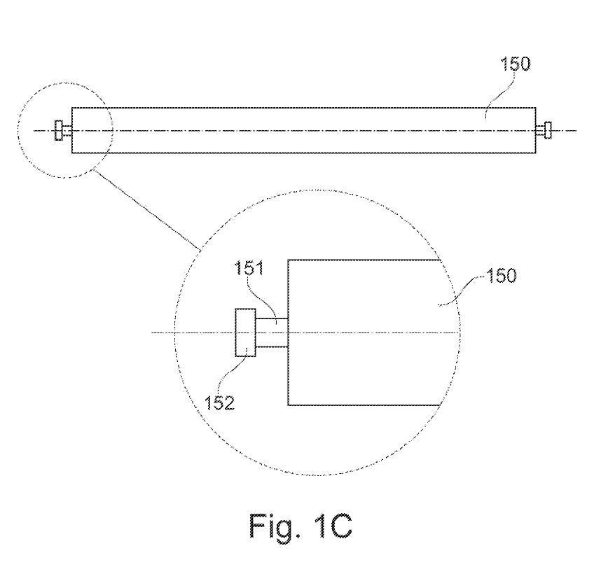

FIG. 2 shows a side view of a lounge module 100 built into a passenger cabin of a transport means, for example an aircraft. As on FIG. 1A, the privacy roller blind 101 is in a retracted state, since it is not in use. Also visible is a second monument 111, for example a galley. Reference number 102 denotes the aisle area to be visually separated from the passenger area by the privacy roller blind 101. For example, this can be a cross aisle (“cross aisle”).

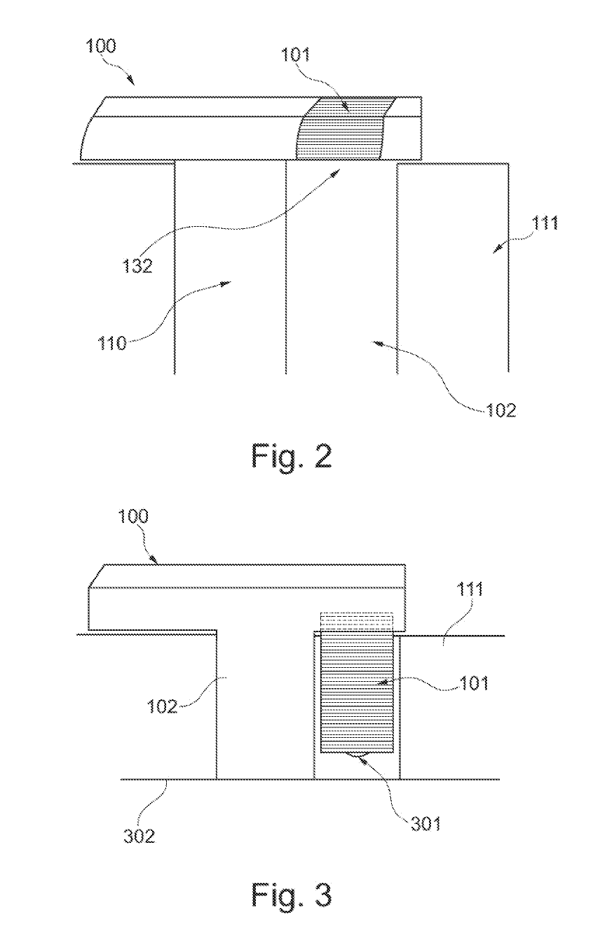

FIG. 3 shows the lounge module 100 on FIG. 2, in which the privacy roller blind 101 is partially lowered. To this end, the privacy roller blind 101 has a tab 301 for pulling the privacy roller blind out of the opening 132 in the ceiling. Reference number 302 denotes the cabin floor.

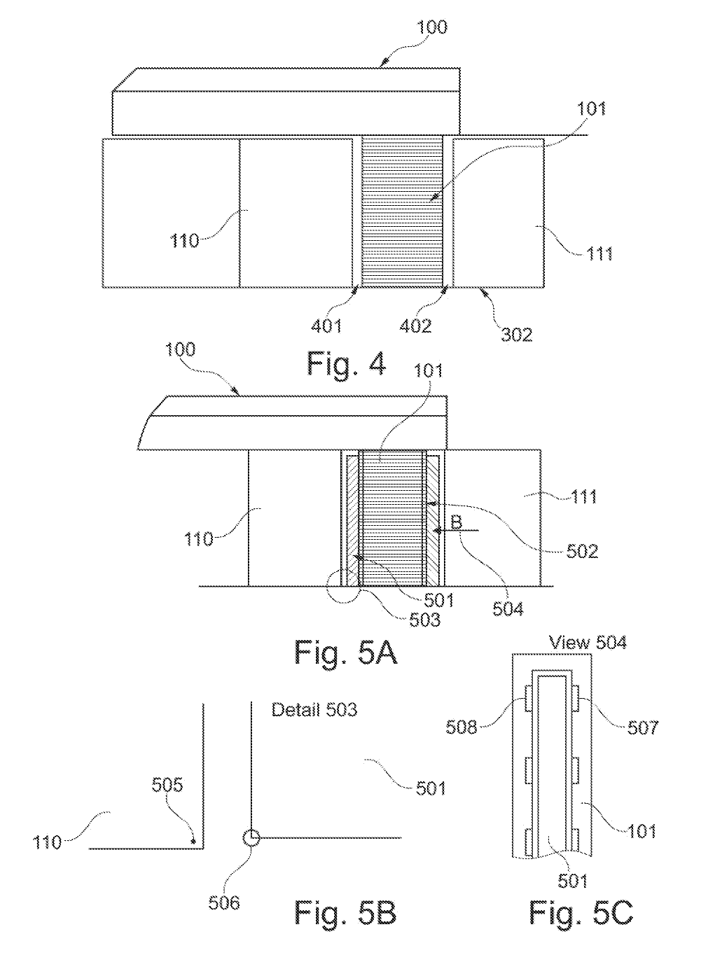

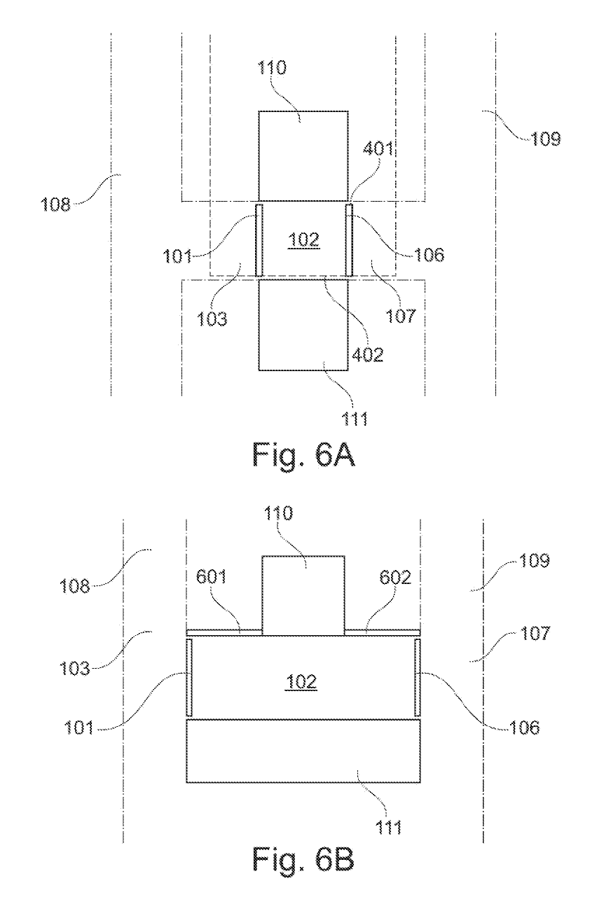

FIG. 4 shows the lounge module 100 on FIG. 2, in which the privacy roller blind 101 is now pulled all the way down to the floor 302. In other words, the privacy roller blind 101 now assumes the extended state. Situated to the left and right of the privacy roller blind 101 are the step-up module 110 and galley module 111. Corresponding laterally extendible panels 501, 502 (see FIG. 5A) can be provided to visually obstruct the visible gap 401, 402 between the privacy roller blind 101 and step-up module 110 or galley module 111. As an alternative, corresponding guide rails for the privacy roller blind can be secured to the interior furnishing elements arranged to the left and right of the privacy roller blind 101.

FIG. 5A shows a lounge module 100 with a privacy roller blind 101, which exhibits such laterally extendible panels 501, 502.

In order to make the variable gaps 401, 402 opaque, the roller blind 101 is provided on both the left and right with rail-mounted “panels” 501, 502, which can be extended of folded out with the privacy roller blind 101 in the extended state.

When extended/folded out, these panels 501, 502 laterally project at least 100 mm from the roller blind 101, for example. For example, outer corners of the panels 501, 502 exhibit eyelets 506 (see FIG. 5B, which presents a detailed view 503 of the lower area of the lateral panel 501). Corresponding counter-pieces 505 are provided on the adjacent interior furnishing elements (monuments 110, 111 or separating walls), for example in the form of simple pins or bolts. These pins 505 protrude out of the monuments or separating walls. These are simple, cylindrical pins with a milled recess in the center to hold the eyelet 506.

FIG. 5C shows a side view 504 of a partial area of the privacy roller blind 101 (in the direction of the arrow 504 on FIG. 5A). Several slide rails 507, 508 are provided inside the roller blind 101 that forms a cavity. These slide rails 507, 508 guide the panels 501 situated inside the cavity.

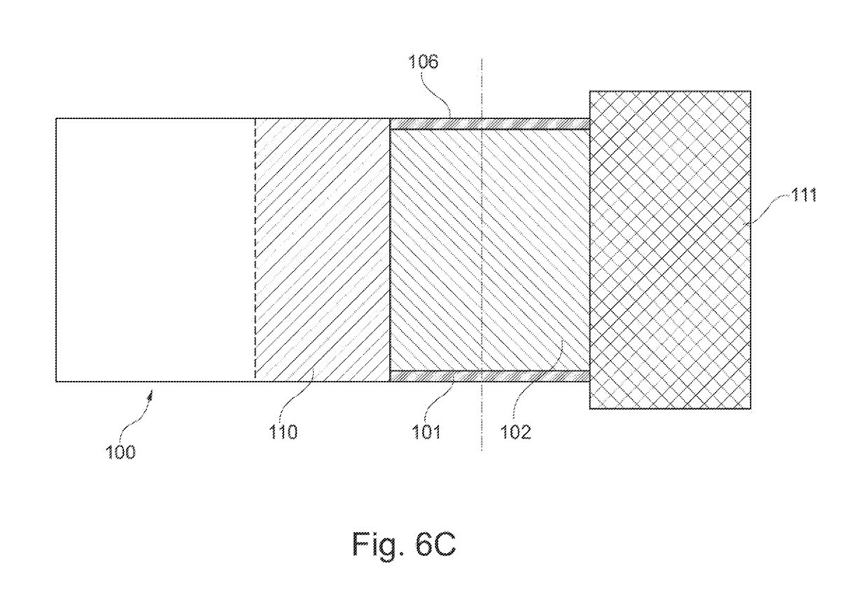

FIG. 6A shows an outline of an arrangement according to an exemplary embodiment of the invention. The floor area of the step-up module 110 is visible, as is the floor area of a galley module 111. The private area or first aisle area 102 to be visually demarcated from other aisle areas 103, 107 is located between these two modules 110, 111. The privacy roller blinds 101, 106 can be lowered in order to achieve this demarcation. The gaps (e.g., see gap 401, 402) between the privacy roller blinds and monuments 110, 111 can be obstructed by corresponding gap covers, which are integrated into/onto the roller blinds, and can be extended/folded out. The monuments 110, 111 can also exhibit lateral guide rails that guide the roller blinds while they are being extended. In this case, no additional gap covers are needed.

The second and third aisle areas 103, 107 adjoin the first aisle area 102 to be demarcated on the left and right. Taken together, these areas constitute the so-called cross aisle (cross aisle) of the passenger cabin. Left and right main aisles 108, 109 adjoin this cross aisle, and are aligned parallel to the longitudinal axis of the aircraft.

FIG. 6B shows an outline of an arrangement according to another exemplary embodiment of the invention. Left and right separating walls 601, 602 adjoin the step-up module 110, and in conjunction with the modules 110, 111 and privacy roller blinds 101, 106 then form the private area 102. As evident from FIG. 6A and 6B, the different elements 110, 111, 101, 106 and possibly 601, 602 completely encompass and define the private area 102. However, it can also be provided that one or both separating walls 601, 602 are absent, so that the private area is only partially visually demarcated. In this case, the fold-out panels would have a larger design to close this gap.

FIG. 6C shows an outline of an arrangement according to another exemplary embodiment of the invention, in which the step-up module 110 along with the galley extends over the entire width of the private area 102, so that the two privacy roller blinds 101, 106 are laterally directly adjacent thereto. Additional separating walls are not needed.

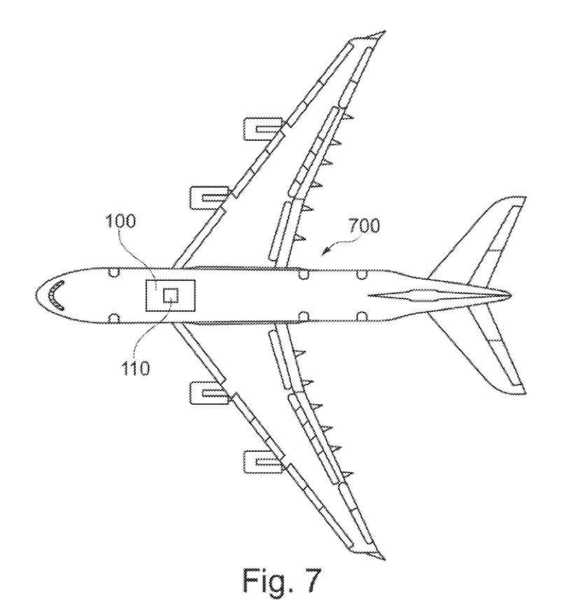

FIG. 7 shows an aircraft 700 with a lounge module 100 according to an exemplary embodiment of the invention. The lounge module 100 can also be arranged in a central area of the passenger cabin, or in a rear area of the passenger cabin, or directly adjacent to the cockpit.

Several such lounge modules may also be provided.

In addition, it should be noted that “exhibit”, “comprise” or “encompass” do not preclude any other elements or steps, and that “a” or “an” do not rule out a plurality.

Let it further be noted that features or steps described with reference to one of the above exemplary embodiments may also be used in combination with other features or steps from other exemplary embodiments described above. Reference numbers in the claims must not be construed as a limitation.

1. An accommodation module for crewmembers of a transport means, to be at least partially arranged in a crown area of a transport means cabin, wherein the accommodation module comprising:
a first privacy roller blind designed to be disposed in a retracted state and an extended state;
wherein the first privacy roller blind in the extended state establishes a first visual separation of a first aisle area from a second aisle area when at least a part of the accommodation module is disposed in a crown area of a cabin of a transport means;
wherein the first aisle area is located underneath the part of the accommodation module when the accommodation module is at least partially disposed in the crown area of the cabin; and
wherein the second aisle area is adjacent to the first aisle area.

2. The accommodation module of claim 1, further comprising:
a second privacy roller blind designed to optionally assume a retracted state and extended state;
wherein the second privacy roller blind is designed to establish a second visual separation of the first aisle area from a third aisle area in the extended state when at least the accommodation module is at least partially disposed in the crown area of the cabin;
wherein the third aisle area adjoins the first aisle area.

3. The accommodation module of claim 1, wherein the first aisle area consists of at least one partial area of a cross aisle between two longitudinal aisles of an aircraft cabin.

4. The accommodation module of claim 1, further comprising:
two grooves for laterally guiding the first privacy roller blind or second privacy roller blind.

5. The lounge module of claim 4, wherein the two grooves are milled into the accommodation module.

6. The lounge module of claim 1 or claim 2, wherein the accommodation module comprises an outer surface;
wherein the first privacy roller blind and/or second privacy roller blind is pushed over at least a partial area of the outer surface in the retracted state.

7. The lounge module of claim 1, further comprising:
a right gap cover and left gap cover, which are integrated into the privacy roller blind when moving the privacy roller blind from the retracted state to the extended state;
wherein the right gap cover and left gap cover can be extended after the privacy roller blind has reached an extended state, so as to obstruct a right gap between the privacy roller blind and a first monument situated adjacent to a right side of the blind and to obstruct a left gap between the privacy roller blind and a second monument situated adjacent to a left side of the blind.

8. The lounge module of claim 1, wherein the privacy roller blind is a flexible roller blind.

9. The lounge module of claim 1, wherein the privacy roller blind is designed as a roller shutter or Venetian blind.

10. An arrangement with a lounge module of claim 1, a first monument and a second monument.

11. An arrangement of claim 10, wherein the two monuments and the two privacy roller blinds in an extended state, optionally in combination with other elements, isolate and define a separated area that can be used by a crewmember to change clothes.

12. The arrangement of claim 10, wherein the first monument is a step-up module for getting into the lounge module, and the second monument is a galley.

13. An aircraft with an accommodation module of claim 1.
